(19) United States
(12) Patent Application Publication
(10) Pub. No.: US 2010/0035450 A1
(43) Pub. Date: Feb. 11, 2010

(54) DOCKING STATION FOR PORTABLE PRODUCT

(75) Inventors: Yu-Kuang CHANG, Taoyuan County (TW); Wen-Kuan Peng, Taoyuan County (TW)

Correspondence Address: RABIN & Berdo, PC, 1101 14TH STREET, NW, SUITE 500, WASHINGTON, DC, 20005, US

(73) Assignee: QUANTA STORAGE INC., Taoyuan County (TW)

(21) Appl. No.: 12/474,712

(22) Filed: May 29, 2009

(30) Foreign Application Priority Data
Aug. 7, 2008 (TW) 97130186

(51) Int. Cl. H01R 13/62

(52) U.S. Cl. 439/152; 439/159

(57) ABSTRACT

A docking station for a portable product is provided. The docking station has a body formed with an opening. A limiting block is formed on a bottom of the body to form a slide way. The limiting block and straight guide slots are on two opposite sides of the slide way. Through holes are formed around a connector in a docking cave. A slider of an ejection device on the slide way has oblique guide slots. A button is inserted into the opening to lean against an inclined surface of the slider. A push block is formed with a slide pin with two ends respectively inserted into the oblique and straight guide slots. A spring having both ends respectively pushing the body and fixed to the slider is for moving the slider to raise the button and locate the slide pin at a low end of the oblique guide slot.

This application claims the benefit of Taiwan application Serial No. 97130186, filed Aug. 7, 2008, the subject matter of which is incorporated herein by reference.

### BACKGROUND OF THE INVENTION

1. Field of the Invention

The invention relates in general to a docking station for a portable product, and more particularly to a docking station which allows a portable product to be inserted therein to be electrically connected to a host and has an ejection device for separating the portable product from the docking station.

2. Description of the Related Art

The functions of a portable product are very simple and limited, so that the large capacity or complicated data processing has to be performed by a host having operating capability with high efficiency. In order to facilitate the connection, the portably product is usually directly inserted into an individual docking station to be connected to the host.

As shown in FIG. 1, United States Patent Publication No. 2006250764 discloses a conventional docking station 1. The docking station 1 is formed with a recess 2. A connector 3 is fixed to a bottom of the recess 2. The connector 3 is electrically connected to a host (not shown) via a cable 4. When a portable product 5 needs to cooperate with the host, the portable product 5 is inserted into the recess 2 and pressed. Thus, the bottom of the portable product 5 is embedded into the connector 3 so as to establish the electrical connection between the portable product 5 and the host, and the portable product 5 can be supported by the docking station 1.

However, as the size of the portable product 5 is not large, the size of the docking station 1 is correspondingly small to save the placement space. When the portable product 5 has to be removed from the docking station 1, the weight of the docking station 1 is insufficient to separate the connected connector therefrom automatically. Instead, a user has to press the docking station 1 with one hand, and apply a force to separate the connected connector with the other hand, so that the portable product 5 can be smoothly removed. As the operation cannot be performed with only one hand, the docking station 1 can not be conveniently used. In addition, the connector 3 of the docking station 1 may get loose and damaged due to the incorrect force applying direction. Thus, the structure of ejecting the portable product in the conventional docking station for the portable product still has problems to be solved.

### SUMMARY OF THE INVENTION

The present invention is directed to a docking station for a portable product. By using a button-type ejection device to forcibly separate the portable product from a connector, the portable product can be conveniently taken out of the docking station.

According to an aspect of the present invention, a docking station for a portable product is provided. By using a button to push a slider, the portable product is pushed away from a connector of the docking station by a push rod so as to separate the connector and the portable product.

According to another aspect of the present invention, a docking station for a portable product is provided. Several push rods around a connector of the docking station are pushed out, so that the portable product is pushed away from the connector so as to prevent the connector from getting loose and damaged.

In order to provide the above-mentioned features, a docking station for a portable product is provided. A side surface of a body of the docking station is formed with an opening. A bottom of the body is formed with a limiting block thereon so as to form a slide way. A plurality of straight guide slots and the limiting block are disposed on opposite sides of the slide way. A docking cave is fixed to the body. A connector is disposed in the docking cave. A plurality of through holes are formed around the connector. An ejection device is disposed in the body. A slider is slidably disposed on the slide way. The slider has one end formed with an inclined surface. The slider further has oblique guide slots. Each oblique guide slot extends from a low end to a high end, and the oblique guide slots are respectively located at positions corresponding to the through holes. A button is inserted into the opening to lean against the inclined surface of the slider. A push block is disposed on the slide way and having slide pins. The slide pins are disposed on the push block at positions respectively corresponding to the oblique guide slots. Each of the slide pins has one end inserted into the corresponding oblique guide slot and the other end inserted into the corresponding straight guide slot. A plurality of push rods are disposed on a top of the push block at positions respectively corresponding to the through holes. The push rods are inserted into the through holes, respectively. A spring has one end touching the body and the other end fixed to the other end of the slider. The spring is used for moving the slider so as to raise the button and locate the slide pins at the low ends of the oblique guide slots.

At least one support wall is disposed at the same side of as the limiting block. In one embodiment of the present invention, the docking station includes two support walls separately disposed along the slide way. The support walls are perpendicular to the slide way to reinforce the support of the slider. Two straight guide slots spaced by a predetermined distance are disposed on a side of the slide way. The slider is formed with two oblique guide slots which are spaced by a predetermined distance. The two oblique guide slots are the same and parallel to each other. Two slide pins of the push block are embedded into the oblique guide slots, respectively. The push block is divided into several parts, and the number of the parts of the push block is the same as the number of the push rods. A bottom of the button is an inclined surface formed with a flange, so that the button is restricted by the opening and is not ejected from the body.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a three-dimensional view showing a conventional docking station.

FIG. 2 is a three-dimensional view showing a docking station for a portable product according to the present invention.

FIG. 3 is an exploded view showing components of the docking station for the portable product according to the present invention.

FIG. 4 is a cross-sectional view showing an initial connection state of the docking station of the present invention.

FIG. 5 is a cross-sectional view showing an ejecting state of the docking station of the present invention.

FIG. 6 is a three-dimensional view showing a push block according to another embodiment of the present invention.

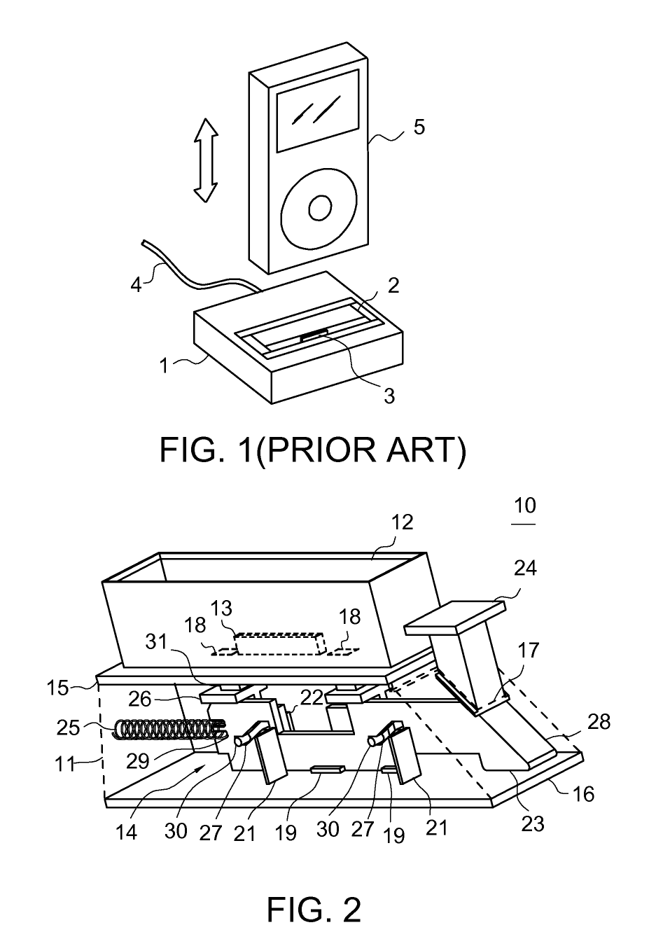

### DETAILED DESCRIPTION OF THE INVENTION

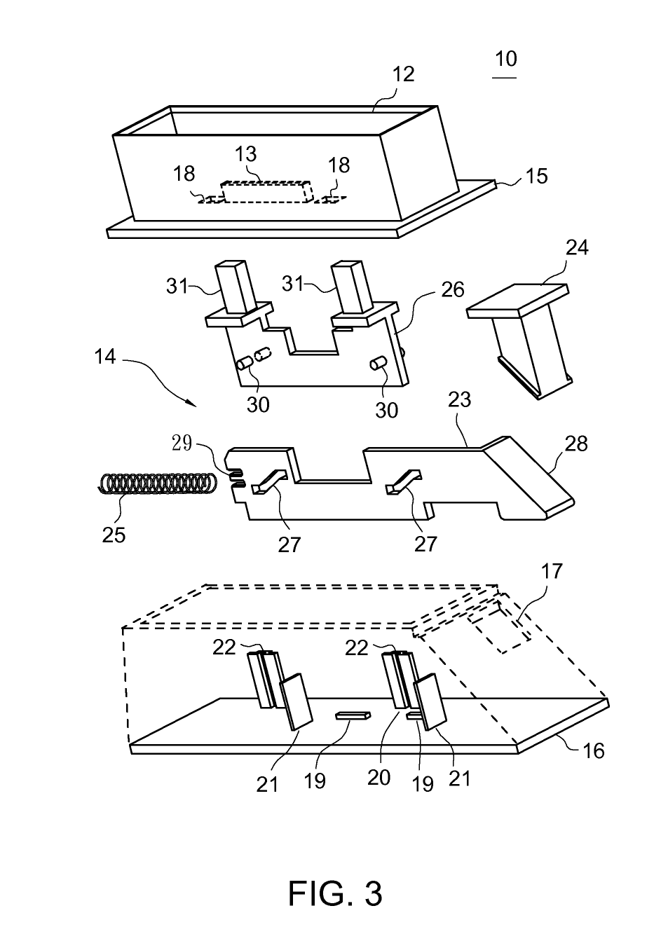

FIG. 2 is an assembly diagram showing a docking station 10 for a portable product according to the present invention. FIG. 3 is an exploded view showing components of the docking station for the portable product according to the present invention. Referring to FIG. 2, the docking station 10 of the present invention is adapted to a portable product, such as a mobile phone, an MP3 player and an external hard drive, etc. The docking station 10 includes a body 11, a docking cave 12, a connector 13 and an ejection device 14. The docking cave 12 is formed on the body 11. The connector 13 is fixed in the docking cave 12. The ejection device 14 is disposed in the body 11.

The body 11 includes an upper cover 15 and a lower cover 16. A hollow chamber is formed between the upper cover 15 and the lower cover 16. A side surface of the body 11 is formed with an opening 17. The docking cave 12 is fixed to the upper cover 15 on the top of the body 11. The connector 13 in the docking cave 12 is disposed on the upper cover 15. Several through holes 18 of the upper cover 15 are formed around the connector 13 to provide a balanced pushing force. In this illustrated embodiment, two through holes 18 are respectively formed near two sides of the connector 13. At least one limiting block 19 is disposed on the lower cover 16 located at the bottom surface inside the body 11 to form a slide way 20 (see FIG. 3). In this embodiment, two limiting blocks 19 separated and arranged in a line are illustrated as an example. In addition, at least one support wall 21 is disposed along the side of the slide way 20 and is disposed on the same side as the limiting blocks 19. In this embodiment, two support walls 21 disposed separately along the slide way are illustrated. The support walls 21 can be perpendicular to the slide way 20 to provide a strong supporting force. Two straight guide slots 22 spaced by a predetermined distance are disposed on the other side of the slide way 20 opposite to the limiting block 19.

The ejection device 14 disposed in the hollow chamber of the body 11 includes a slider 23, a button 24, a spring 25 and a push block 26. The slider 23 is an L-shaped plate. The slider 23 has two oblique guide slots 27 at positions corresponding to the through holes 18. Each oblique guide slot 27 extends from a low end to a high end. The two oblique guide slots 27 have the same height and are parallel to each other. The slider 23 has an L-shaped end formed with an inclined surface 28, and the other end formed with a fixing recess 29 for fixing the spring 25. The bottom of the button 24 is an inclined surface, which leans against the inclined surface 28 to slide, and a flange is formed around the inclined surface. The push block 26 is basically a flat plate. Slide pins 30 respectively disposed at positions corresponding to the oblique guide slots 27 project out of two surfaces of the push block 26. The positions of push rods 31 disposed on the top of the push block 26 respectively correspond to those of through holes 18. The push rods 31 can be moved into and out of the through holes 18.

When the docking station 10 of the present invention is assembled, an end of each slide pin 30 of the push block 26 is embedded into the corresponding oblique guide slot 27, so that the push block 26 leans against the slider 23. Then, the bottoms of the slider 23 and the push block 26 are placed onto the slide way 20, so that the other end of each slide pin 30 projecting from the push block 26 is embedded into the corresponding straight guide slot 22, and the push rods 31 are inserted into the through holes 18, respectively. The support walls 21 and the straight guide slots 22 disposed beside the slide way 20 support the slider 23 and the push block 26 from two sides, so that the slider 23 and the push block 26 stand on the slide way 20, and the slider 23 slides along the lower cover 16 on the slide way 20. The push block 26 is restricted by the straight guide slots 22 to be moved up and down along the straight guide slots 22 and perpendicular to the lower cover 16. Thus, the push block 26 can not slide together with the slider 23. The button 24 is inserted into the opening 17 of the body 11 and has a bottom formed with an inclined surface pressing against the inclined surface 28 at one end of the slider 23. The bottom of the button 24 is formed with a flange, so that the button 24 is restricted by the opening 17 and is not ejected from the body. The fixing recess 29 at the other end of the slider 23 is used for fixing the spring 25.

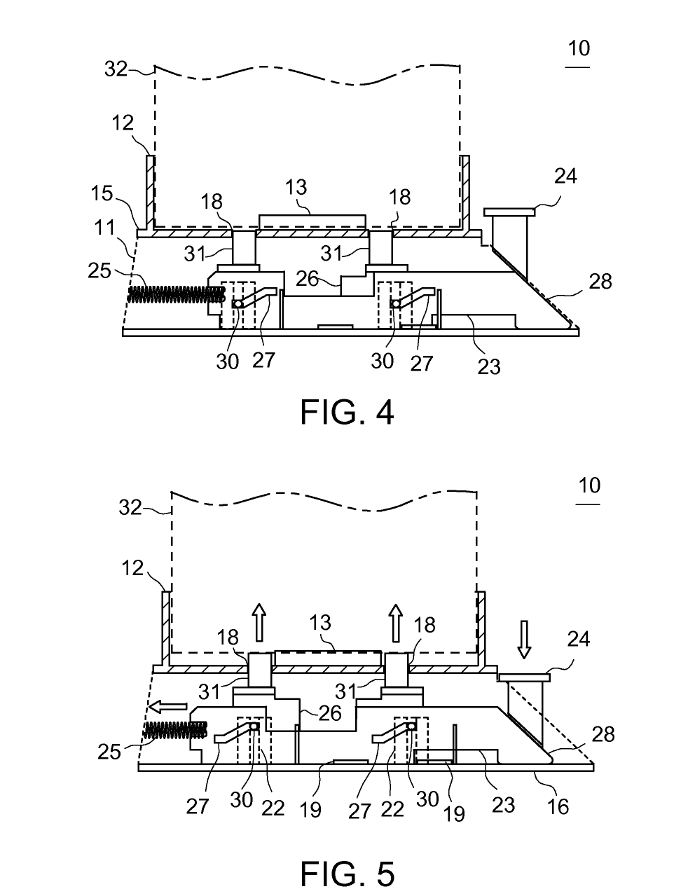

FIG. 4 is a cross-sectional view showing a connection state of the docking station of the present invention. The spring 25 pushes against the body 11, so that the slider 23 is moved accordingly. Thus, the inclined surface 28 of the slider 23 pushes the button 24 upwards, and the slide pins 30 are located at lower ends of the oblique guide slots 27, so that the push block 26 is moved down to the lowest position. The push rods 31 are moved into the through holes 18, so that the docking station 10 is in the initially assembled state. When a portable product 32 is inserted into the docking cave 12, the portable product 32 is electrically connected to the connector 13 in the docking cave and is supported by the docking cave 12 to stand on the upper cover 15.

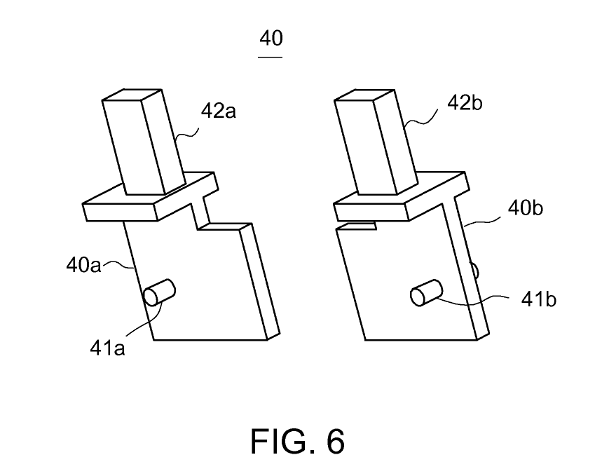

FIG. 5 is a cross-sectional view showing an ejecting state of the docking station of the present invention. When the portable product 32 needs to be removed, the button 24 has to be pressed down in a direction indicated by the arrow above the button 24, and the bottom of the button 24 pushes the inclined surface 28 to resist the elastic force of the spring 25. Thus, the slider 23 is moved along the limiting blocks 19 of the lower cover 16 in a direction indicated by the horizontal arrow. As the push block 26 is restricted by the straight guide slots 22, the push block 26 can not slide with the slider 23. One end of each slide pin 30 is moved to the high end along the oblique guide slot 27, the other end of each slide pin 30 only can be moved vertically upwards along the straight guide slot 22. Thus, the push block 26 is forced to move vertically upwards to drive the push rods 31 to move out of the through holes 18 in a direction as indicated by the vertical arrows. The portable product 32 is pushed upward in a balanced manner by the push rods 31 around the two ends of the connector 13, so that the portable product 32 is disconnected from the connector 13 and stays in the docking cave 12. Then, the button 24 is released. Under the action of the elastic force of the spring 25, the ejection device 14 returns to the initial state. After that, the portable product 32 can be easily taken out.

FIG. 6 shows a push block 40 of an ejection device according to another embodiment of the present invention. As shown in FIG. 6, the basic architecture of the push block 40 is the same as that of the previous embodiment. In the previous embodiment, the push block is integrally formed. However, the object of the present invention still can be achieved by dividing the push block into several parts which can operate individually. Therefore, in the present embodiment, the push block 40 is divided into several parts according to the number of the push rods. The number of the parts of the push block 40 is the same as that of the push rods. In this embodiment, two push rods are provided as an example. The push block 40 is divided into two parts 40a and 40b. The parts 40a and 40b respectively include slide pins 41a and 41b, and push rods 42a and 42b. Thus, the object of the present invention still can be achieved by moving each of the push blocks 40a and 40b up and down in a vertical direction.

In the docking station for the portable product according to the present invention, the button-type ejection device can push the slider to force the push block to move upwards, so that the push rods project from the periphery of the connector and the portable product can be pushed away from the connector in the balanced manner. Thus, the situation that the connector gets loose and damaged can be avoided, and the portable product can be easily taken out using a single hand to conveniently operate.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A docking station for a portable product, the docking station comprising:
a body having a hollow chamber, wherein a side surface of the body is formed with an opening, a bottom of the body is formed with at least one limiting block so as to form a slide way, the limiting block and a plurality of straight guide slots are disposed on opposite sides of the slide way;
a docking cave fixed to the body, wherein a connector is disposed in the docking cave, and a plurality of through holes are formed around the connector; and
an ejection device disposed in the body, the ejection device comprising:
a slider slidably disposed on the slide way, wherein the slider has one end formed with an inclined surface, the slider further has oblique guide slots, each oblique guide slot extends from a low end to a high end, and the oblique guide slots are located at positions respectively corresponding to the through holes;
a button inserted into the opening to lean against the inclined surface of the slider;
a push block disposed on the slide way and having slide pins, wherein the slide pins are disposed on the push block at positions respectively corresponding to the oblique guide slots, each of the slide pins has one end embedded into the corresponding oblique guide slot and the other end embedded into the corresponding straight guide slot, a plurality of push rods are disposed on a top of the push block at positions respectively corresponding to the through holes, and the push rods are inserted into the through holes, respectively; and
a spring having one end pushing the body and the other end fixed to the other end of the slider, wherein the spring is used for moving the slider so as to raise the button and locate the slide pins at the low ends of the oblique guide slots.

2. The docking station according to claim 1, wherein the body comprises an upper cover and a lower cover, and the hollow chamber is formed between the upper cover and the lower cover.

3. The docking station according to claim 2, wherein the lower cover is formed with the limiting block and the straight guide slots thereon.

4. The docking station according to claim 2, wherein the docking cave is fixed to the upper cover of the body.

5. The docking station according to claim 1, wherein the slider is an L-shaped plate having an L-shaped end, and the L-shaped end is formed with the inclined surface.

6. The docking station according to claim 1, wherein the docking station comprises two limiting blocks which are separated and arranged in a line beside the slide way.

7. The docking station according to claim 6, wherein at least one support wall is disposed at the same side of the slide way as the limiting block

8. The docking station according to claim 7, wherein two support walls are disposed at the same side of the slide way as the limiting block and separately disposed along the slide way.

9. The docking station according to claim 7, wherein the support wall is perpendicular to the slide way.

10. The docking station according to claim 1, wherein the straight guide slots are spaced by a predetermined distance on the side of the slide way.

11. The docking station according to claim 10, wherein two through holes are respectively formed on two sides of the connector.

12. The docking station according to claim 10, wherein the slider is formed with two oblique guide slots which are spaced by another predetermined distance.

13. The docking station according to claim 12, wherein the two oblique guide slots are the same and parallel to each other.

14. The docking station according to claim 1, wherein the other end of the slider is formed with a fixing recess for fixing the spring.

15. The docking station according to claim 1, wherein a bottom of the button is an inclined surface formed with a flange, so that the button is restricted by the opening and is not ejected from the body.

16. The docking station according to claim 1, wherein the push block is divided into several parts, and the number of the parts of the push block is the same as the number of the push rods.
